(19) United States
(12) Patent Application Publication
(10) Pub. No.: US 2025/0007200 A1
(43) Pub. Date: Jan. 2, 2025

(54) BUILT-IN PLUG-IN CONNECTOR HOUSING MADE FROM SOFT MATERIAL

(71) Applicant: Neutrik AG, Schaan (LI)

(72) Inventors: Oliver DOBLER, Tschagguns (AT); Martin MAIKISCH, Satteins (AT)

(73) Assignee: Neutrik AG, Schaan (LI)

(21) Appl. No.: 18/520,888

(22) Filed: Nov. 28, 2023

(30) Foreign Application Priority Data
Jun. 27, 2023 (EP) 23181911.1

(51) Int. Cl. H01R 13/514; H01R 13/502; H01R 13/52

(52) U.S. Cl. CPC H01R 13/514; H01R 13/5025; H01R 13/5213

(57) ABSTRACT

A built-in plug-in connector 2 that includes: at least one contact element 9, a contact element carrier 7, the at least one contact element 9 being received by the contact element carrier 7 and thus being fixed within the built-in plug-in connector 2, and a housing pot 1, the contact element carrier 7 being inserted at least partially into the housing pot 1, the housing pot 1 being made from a material with a Shore A hardness in the range from 60 to 100.

### CROSS-REFERENCE TO RELATED APPLICATIONS

This application claims priority to European Patent Application No. 23181911.1, filed Jun. 27, 2023, which is incorporated herein by reference as if fully set forth.

### TECHNICAL FIELD

The present invention relates to a built-in plug-in connector, the built-in plug-in connector being provided for entering into an (in particular, mechanically lockable) plug-in connection with a cable plug-in connector which is matched to the built-in plug-in connector as counterpart and can be plugged into an opening of the built-in plug-in connector.

### BACKGROUND

Built-in plug-in connectors with a multiple-part construction are known from the prior art. Here, the contact pins (often also called pins or sheets) are pushed into a contact carrier, this contact carrier also having, in addition to receiving and orienting of the contact pins, the function, inter alia, providing the interior space, into which the cable plug-in connector for establishing the contact with the contact pins is inserted. In addition, this interior space can have elements for locking the cable plug-in connector. Furthermore, in specific embodiments of built-in plug-in connectors of this type, the contact carrier provides a connecting flange, through the mounting bores of which screws for screwing the built-in plug-in connector to a mounting plate can be guided.

The contact carrier is pushed into a built-in plug-in connector housing, parts of the contact pins being pushed out of the built-in plug-in connector housing again through openings which are provided specifically for this purpose. These parts of the contact pins which protrude out of the housing are then each connected, for example via terminals which are provided specifically for this purpose, to strands of a cable, for example of a power cable, which cable provides the signal provided for transmission via the plug-in connection of the built-in plug-in connector and the cable plug-in connector, for example a power supply signal.

In the case of built-in plug-in connectors of the prior art, the built-in plug-in connector housing is manufactured from a hard, inelastic material (for example, a relatively hard thermoplastic), this relatively hard housing thus not bearing tightly against the contact pins which are pushed out through the openings of the housing. As a consequence, these press fits between built-in plug-in connector housings of the prior art and corresponding contact pins are leaky/permeable for dust, water and/or air.

A leak of this type between the housing in the contact pin is a problem, in particular, in the case of applications of the built-in plug-in connector in the outdoor area (for example, loudspeaker boxes at open-air festivals). Rainfall can occur here at any time, for example, it being possible for moisture to penetrate into the built-in plug-in connector if no cable plug-in connector is plugged in and the sealing cap which is provided for temporary closure and sealing of the built-in plug-in connector interior space has not been placed on it. The penetrated moisture can then run as far as the press fit between the built-in plug-in connector housing and the contact pin and can collect there. Since, as has already been addressed, this press fit is not tight, in particular with respect to water, on account of the relatively hard housing material, there is the risk in the case of built-in plug-in connectors of the prior art that the moisture penetrates further as far as into the unit and thus leads to a short circuit which can damage the unit and in the worst-case can injure bystanding persons.

Built-in plug-in connectors of the prior art solve the described problem by virtue of the fact that contact points of the contact pins with the housing are sealed and additionally by way of sealing means such as, for example, adhesives, sealing pastes, sealing rings (for example, O-rings), etc. Here, however, a disadvantage of the built-in plug-in connector housings or the built-in plug-in connectors of the prior art is shown, since these additional components/sealing materials firstly cause additional costs (for example, material procurement costs, additional machines/employees) and secondly cause an additional workload as a result of, for example, further working steps. Thus, for example before the built-in plug-in connector is assembled by way of plugging together of built-in plug-connector housing, contact carrier and contact pins, the corresponding sealing rings have to be inserted/plugged on or the adhesive which is still liquid has to be applied.

### SUMMARY

It is therefore an object of the invention to provide a built-in plug-in connector and a built-in plug-in connector housing which overcome the disadvantages from the prior art, in particular in view of the strict requirements in relation to safety and the worldwide established mounting dimensions.

A further object lies in providing a built-in plug-in connector and a built-in plug-in connector housing, in the case of which the production of the seal with respect to dust, air and/or water is simplified, as a result of which an application in the outdoor area, a reduction in the risk of short-circuits and/or compliance with certain standards become/becomes possible without an additional workload.

These objects are achieved by way of the implementation of one or more of the features disclosed herein. Features which develop the invention in an alternative or advantageous way can be gathered from some of the remaining features explained below and noted in the claims.

The invention relates to a built-in plug-in connector for entering into an, in particular, mechanically lockable, plug-in connection with a cable plug-in connector which is matched to the built-in plug-in connector as counterpart and can be plugged into an opening of the built-in plug-in connector, a signal transmission being enabled by way of entering of the plug-in connection between the built-in plug-in connector and the cable plug-in connector, in particular of a current supply signal, a digital signal or an analog signal, the built-in plug-in connector being provided to be fastened to a mounting plate. The built-in plug-in connector comprising:
at least one (signal transmission) contact element, the at least one contact element being provided to come into contact with a cable plug-in connector-side (signal transmission) contact element counterpart by way of entering into the plug-in connection and, as a result, to provide a signal transmission over the plug-in connection,
a contact element carrier, (the contact element carrier providing that opening of the built-in plug-in connector (called plug-in opening in the following text) which is provided for plugging in the cable plug-in connector), the at least one contact element being received by the contact element carrier and thus being fixed within the built-in plug-in connector, and
a pot-shaped built-in plug-in connector housing, called a housing pot in the following text, the contact element being inserted at least partially into the housing pot, the housing pot is made from a material with a Shore A hardness in the range from 60 to 100.

In one exemplary embodiment of the built-in plug-in connector according to the invention, the housing pot is made from a material with a Shore A hardness in the range from 65 to 95, in particular in a range from 75 to 95. In the case of the selection of the hardness of the material, and/or the selection of the composition of the components which provide the hardness of the material, the aspects of tightness and processing capability have to be considered. If the material is namely selected to be too hard, although the processing capability is simplified, in particular by means of injection moulding methods, the sealing action is reduced. In the case of an excessively soft material, although the sealing action is highly satisfactory, fine structures such as, for example, sealing lips are difficult to manufacture (for example, undercuts are scarcely possible using the injection moulding method). In particular in the case of a Shore A hardness in a range from 65 to 95, both the seal and the processing capability of the housing pot are ensured.

In one exemplary embodiment of the built-in plug-in connector according to the invention, the material consists at least predominantly of a plastic.

The material of the housing pot can thus consist, for example, of at least 60%, in particular of at least 80%, of the plastic, additives such as, for example, plasticizers or fire prevention substances being added to the plastic. In particular for built-in plug-in connectors of the type powerCON (powerCON female receptacles) from the company Neutrik AG from Liechtenstein (also known under the name Neutrik Group), it is of great significance that the material of the housing pot is flame-retardant, which is achieved, for example, by way of the addition of fire prevention substances to the material of the housing pot.

In a further embodiment of the built-in plug-in connector according to the invention, the plastic is a thermoplastic (or a thermoplastic elastomer), in particular one of the following thermoplastics:
polypropylene,
polyethylene,
polyurethane (for example, “thermoplastic polyurethane”),
further thermoplastic elastomers (for example, styrene ethylene butylene styrene (SEBS)), or
polystyrene.

In a further embodiment of the built-in plug-in connector according to the invention, the housing pot has:
a housing shell which is, in particular, cylindrical (the housing shell running around a centre axis of the housing pot, the centre axis of the housing pot corresponding, in particular, to a longitudinal axis of the housing pot),
a plug-in-side end (which forms a top surface), a (contact element carrier) insertion opening extending within the plug-in-side end, through which insertion opening the contact element carrier is inserted at least partially into the housing pot (in the axial direction of the centre axis), and
a housing bottom (which is, in particular, circular and forms a base surface), at least one (contact element) push-out opening extending within the housing bottom, through which push-out opening the contact element is pushed at least partially out of the housing pot (in the axial direction of the centre axis) (a housing interior space being delimited at least by the housing shell and the housing bottom).

The axial direction of the centre axis of the housing pot is understood to mean the direction, in which the centre axis runs from the plug-in-side end of the housing (top surface) towards the housing bottom (base surface). This direction also corresponds, inter alia, to the insertion direction of the contact element carrier into the housing pot, and to the plug-in direction of the cable plug-in connector into the contact element carrier (or the plug-in direction of the cable plug-in connector into the built-in plug-in connector).

Here, the at least one contact element is received, for example, by the contact element carrier in such a way that a first part region of the contact element plugs into the contact element carrier and is fixed there, for example, by means of interlocking, jamming or adhering, while a second part region of the contact element protrudes out of the end piece of the contact element carrier, which end piece is inserted through the insertion opening into the housing pot. Since the contact element carrier is inserted into the housing pot to such an extent that this end piece bears against the housing bottom, that second part of the contact element which protrudes out of the end piece is pushed through the push-out opening out of the housing pot. As a consequence, it can also be said that the at least one contact element is received at least partially by the contact element carrier and is thus fixed at least partially within the built-in plug-in connector.

In a further embodiment of the built-in plug-in connector according to the invention,
the at least one push-out opening has a geometrical shape which corresponds at least largely to the geometrical shape of a cross-sectional area, running orthogonally with respect to a longitudinal axis through the at least one contact element, of the at least one contact element (“at least largely” means here that the respective shape is in principle identical, but, for example, angles can differ in the single-digit angular range, or sides of the shape can be curved inwards or outwards somewhat),
the at least one push-out opening extends within the housing bottom with an area which is smaller than or equal to the said crossover sectional area of the at least one contact element, and/or
the at least one push-out opening bears with an area which (runs around at least one push-out opening and) extends into the at least one push-out opening (over an entire thickness of the housing bottom) (in other words, the inner area of the push-out opening) against the contact element which is pushed at least partially through the at least one push-out opening, in such a way that a press fit is configured between the said area and the contact element which is pushed at least partially through the at least one push-out opening (after all, only the second part region of the contact element is pushed through the push-out opening, since the first part region of the contact element is fixed within the contact element carrier) over the entire thickness of the housing bottom, in particular wherein
the area which extends into the at least one push-out opening not being opened out by way of the contact element which is pushed out (in the axial direction of the centre axis),
the housing bottom having a thickness in the range from 0.5 mm to 3 mm, in particular from 1.5 mm to 2 mm, and/or
the press fit which is configured (between the area which extends into the at least one push-out opening and the contact element which is pushed through the at least one push-out opening) being impermeable for water and/or air (both in the direction from the housing interior space towards an outer side of the housing pot and in a direction from the outer side of the housing pot towards the housing interior space).

The configuration according to the invention of the built-in plug-in connector with a housing pot made from a softer, more elastic material then in the case of built-in plug-in connectors of the prior art has the advantage that the housing pot and the at least one push-out opening can be manufactured with dimensions which are such that firstly the housing pot bears tightly against the contact element carrier during pushing in of the latter which is manufactured, for example, from a hard plastic (for example, a harder thermoplastic), and secondly the at least one push-out opening bears tightly against the contact element which is guided through it. In other words, the push-out opening has a somewhat smaller area than the cross-sectional area of that part of the contact element which is pushed through the push-out opening out of the housing pot, with the result that the push-out opening expands during pushing out of the contact element, for which a certain force has to be applied. The area which extends into the push-out opening then pushes on the contact element with this force which counteracts this expansion, as a result of which what is known as a press fit is configured between the push-out opening in the contact element. By virtue of the fact that the housing pot of the built-in plug-in connector according to the invention is manufactured from a softer, more elastic material (for example, comparable with rubber), it can firstly expand more simply and can secondly bear tightly against the contact element in an improved manner. In this way, press fits between the soft, elastic housing pot and the harder, inelastic contact element are impermeable for dust, water and/or air, as a result of which the entire built-in plug-in connector, in the built-in state, is dust-tight, water-tight and/or air-tight, even if one has forgotten, for example in the case of rainfall, to pull the sealing cap over the plug-in opening of the built-in plug-in connector, and water has been able to pass into the built-in plug-in connector as a result.

As a result of the water-tight and/or air-tight press fit between the soft, elastic housing pot and the at least one contact element, the built-in plug-in connector which has the housing pot according to the invention is capable, even in the case of a sealing cap which has not been placed on or a cable plug-in connector which has not been plugged in, of fulfilling the IP 65 and/or IP 67 standards, without it being necessary for additional components/sealing materials (such as, for example, a liquid sealant which hardens after the application) having to be used for this purpose. As a consequence, firstly additional costs (for example, material procurement costs, additional machines/employees) and secondly an additional workload as a result of, for example, further working steps can be saved by way of the built-in plug-in connector according to the invention. These additional costs/working steps therefore do not occur in the case of the built-in plug-in connector according to the invention, since no further sealing is required as a result of the water-impermeable and/or air-impermeable press fits, for which reason the disadvantages of the prior art are overcome.

The use of a thermoplastic (or a thermoplastic elastomer) as main constituent part for the soft material has the advantage, inter alia, that manufacturing of the housing pot by means of injection moulding methods, pressing or vulcanizing can be realised, and that the housing has an insulating effect with respect to electrical current.

As has already been described, the, in particular, three push-out openings in the housing bottom are particularly sensitive locations of the housing pot, in the case of which leaks often occur. In the case of built-in plug-in connector housings from the prior art which, as has already been described, as a rule consist of a harder material, in particular predominantly from a harder thermoplastic (or thermoplastic elastomer), an attempt is made to seal the contact region between the edge of the push-out opening and the contact element which is pushed through this opening by virtue of the fact that the push-out opening is configured with a smaller area than the cross-sectional area of the contact element. In this way, during pushing out of the housing interior space, the contact element presses onto the edge of the push-out opening and opens this edge to the outside. The outwardly opened edge of the push-out opening is then provided with a sealing paste, for example.

In the case of an embodiment of this type, however, a slight positive pressure within the built-in plug-in connector is sufficient to press on the outwardly opened edge region of the push-out opening and thus again to produce a leak of the built-in plug. A positive pressure of this type can be triggered here by way of temperature fluctuations within the unit, for example by way of rapid heating of the unit in the case of direct insolation.

The abovementioned exemplary embodiment of the built-in plug-in connector according to the invention solves this problem by virtue of the fact that the geometrical shape of the push-out opening is adapted to the shape of the cross-sectional area of the contact element. This means that, for example in the case of a flat, rectangular contact element (frequently also called a sheet) which has a rectangular cross-sectional area, the push-out opening is likewise of rectangular configuration. As an alternative or in addition to this, the area of the push-out opening is, for example, of only somewhat smaller configuration than the cross-sectional area of the contact element, as a result of which the edge of the push-out opening is not opened outwards during pushing through of the contact element. In this way, the press fit of the contact element in the push-out opening bears against the contact element over the entire area within the push-out opening, and is not pressed open by way of a positive pressure within the built-in plug.

In a further embodiment, in the case of a cross-sectional area of rectangular shape of the at least one contact element, the at least one push-out opening has a largely rectangular shape, the two longer rectangle sides being configured in the case of this largely rectangular shape as bulges/curvatures which are directed towards a rectangle centre point, the at least one push-out opening thus having, in particular, at least largely a shape which resembles a biconcave lens.

The abovementioned exemplary embodiment of the built-in plug-in connector according to the invention has the advantage that, as a result of the housing bottom of particularly thick configuration, the press fit between the contact element and the push-out opening is configured over a greater area on the contact element than in the case of the prior art with considerably thinner housing bottoms. This greater area of the press fit brings about an improved seal on account of the sealing area which is increased as a result, and improved additional retention of the contact element within the push-out opening on account of the supporting area which is increased as a result. Furthermore, when pushing a contact element through the push-out opening, the housing bottom is not opened to the outside on account of its increased stability which is provided by way of the additional thickness, as a result of which the press fit bears against the contact element over the entire area within the push-out opening and is not pressed open as a result of a positive pressure within the built-in plug.

In a further embodiment, the contact element carrier has:
a plug-in opening which is provided for plugging in the cable plug-in connector,
a contact element carrier interior space which extends from the plug-in opening as far as an end piece which is spaced apart from the plug-in opening (in the axial direction of the centre axis of the contact element carrier), (the contact element carrier interior space being provided to receive the plug-in cable plug-in connector), the end piece
providing a stop for the plug-in cable plug-in connector, and
at least one contact element receiving opening (the first part region of the contact element is guided through this receiving opening and is then fixed within the contact and carrier), and
a connecting flange (which extends orthogonally with respect to the centre axis of the contact element carrier/radially to the outside), the connecting flange being arranged at the plug-in opening.

By virtue of the fact that the connecting flange extends radially further to the outside than the diameter of the insertion opening, the connecting flange prevents it being possible for the contact element carrier to be inserted completely into the housing pot. That end of the contact element carrier which has the connecting flange therefore remains outside the housing pot, for which reason the contact element carrier is inserted at least partially into the housing pot.

In a further embodiment, the plug-in-side end of the housing pot has a flange-like projection (which extends orthogonally with respect to the centre axis of the housing pot/radially), the flange-like projection
being placed onto the connecting flange of the contact element carrier on a side, directed counter to the insertion direction of the contact element carrier into the housing pot, of the flange-like projection (that is to say, on that side of the flange-like projection which is directed counter to the axial direction of the centre axis of the housing pot), and/or
being capable of being placed onto a mounting plate on a side, directed in the axial direction with respect to the insertion direction of the contact element carrier into the housing pot, of the flange-like projection (that is to say, on that side of the flange-like projection which is directed in the axial direction of the centre axis of the housing pot), in particular wherein the flange-like projection having an at least largely identical shape and extent to the connecting flange of the contact element carrier, with the result that the flange-like projection which is placed onto the connecting flange of the contact element carrier terminates at least largely flush with the connecting flange of the contact element carrier.

In a further embodiment, the flange-like projection has a first sealing lip, the first sealing lip
being arranged on that side of the flange-like projection which is directed counter to the insertion direction of the contact element carrier into the housing pot,
running completely around the flange-like projection, and/or
being placed onto the connecting flange of the contact element carrier in such a way that a press fit is configured between the first sealing lip and the connecting flange of the contact element carrier, the press fit which is configured between the first sealing lip and the connecting flange of the contact element carrier being, in particular, impermeable (in both directions) for water and/or air.

In a further embodiment, the flange-like projection has (on the side which is directed counter to the axial direction of the centre axis):
at least one elevation (which is directed counter to the axial direction of the centre axis), the at least one elevation of the flange-like projection being pushed into at least one depression, matching it, of the connecting flange in such a way that a press fit is configured between the elevation of the flange-like projection and the depression, matching it, of the connecting flange, and/or
at least one depression (which is directed in the axial direction of the centre axis), the at least one depression of the flange-like projection having received at least one elevation, matching it, of the connecting flange in such a way that a press fit is configured between the depression of the flange-like projection and the elevation, matching it, of the connecting flange.

In a further embodiment, at least one connecting strip which projects radially (in a direction orthogonally with respect to the centre axis of the housing pot) is moulded on the flange-like projection, to the outer end of which connecting strip a sealing plug which is, in particular, pot-shaped is fastened, the sealing plug which is, in particular, pot-shaped having an external diameter which is slightly greater (in the millimetre range) than an internal diameter of a plug-in opening of the contact element carrier, with the result that, when the sealing plug which is, in particular, pot-shaped is pushed into the plug-in opening, a press fit is configured between the sealing plug which is, in particular, pot-shaped and an area which (runs around the plug-in opening and) extends in the plug-in opening (that is to say, the inner area of the plug-in opening), in particular
a full-surface grip tab projecting on that side of the sealing plug which lies opposite the connecting strip, and/or
the press fit which is configured between the sealing plug which is, in particular, pot-shaped and the area which extends into the plug-in opening being impermeable for water and/or air (both in a direction from a contact element carrier interior space towards an outer side of the contact element carrier and in a direction from the outer side of the contact element carrier towards the contact element carrier interior space).

In a further embodiment, the flange-like projection has a rectangular shape, in particular with rounded corners, the radially projecting connecting strip being moulded, in particular in a central/centred manner, on a side of the flange-like projection, the radially projecting connecting strip being moulded, in particular, on the side of the flange-like projection in such a way that an angle in the range from 70° to 110°, in particular 90°, is configured between the side of the flange-like projection and that the connecting strip.

In a further embodiment, the flange-like projection has a rectangular shape, in particular with rounded corners, the radially projecting connecting strip being moulded on a corner which is, in particular, rounded of the flange-like projection, in particular wherein the radially projecting connecting strip being moulded on the corner which is, in particular, rounded of the flange-like projection in such a way that an angle in the region from 120° to 140°, in particular 135°, is configured between the longer side of the two sides which form the said corner which is, in particular, rounded of the flange-like projection.

In the case of built-in plug-in connectors according to the prior art, the radially projecting connecting strip together with the sealing plug which is attached to it is not configured as part of the housing pot, but rather as a separate part which is attached centrally to a side of the connecting flange. Here, for example, this part is attached in such a way that the connecting strip protrudes perpendicularly upwards or perpendicularly downwards, that is to say a 90° angle is configured between the corresponding side of the connecting flange and a connecting strip. An arrangement of this type of the connecting strip at the disadvantage, however, that, in the case of a perpendicular arrangement of a plurality of built-in plug-in connectors next to one another, which arrangement is certainly customary in loudspeaker boxes, for example, the connecting strip and the sealing plug protrude beyond the plug-in opening of the built-in plug-in connector which is arranged directly above or below, and thus impede the plug-in operation in the case of this built-in plug-in connector.

The above-described exemplary embodiment of the invention has the advantage that, as a result of the arrangement at a corner of the flange-like projection of the housing and the orientation, running, for example, along the diagonal of the flange-like projection, of the connecting strip, the connecting strip and the sealing plug protrude next to one another, in the case of a perpendicular arrangement of a plurality of built-in plug-in connectors, past the built-in plug-in connector lying above or below them, and the plug-in operation is thus not disrupted. Here, in particular, the connecting strip is oriented obliquely upwards (and not obliquely downwards), since no rainwater can collect in the sealing plug in this way. In the case of an arrangement of four built-in plugs according to the invention in a square 2×2 arrangement, the respective connecting strip can be arranged, in particular, at the corner which is directed towards the centre of the 2×2 arrangement, as a result of which all four connecting strips and sealing plugs protrude into the centre. In this way, a plurality of built-in plug-in connectors which are provided with the housing pot according to the invention can be arranged in a very small space, without it being necessary for the disadvantages of the prior art to be accepted.

In a further embodiment, the flange-like projection has two recesses, in particular arranged in obliquely opposite rounded corners of the flange-like projection, for leading through fastening means, provided to fasten the built-in plug-in connected to the mounting plate, the two recesses being positioned coaxially with respect to mounting bores, in particular arranged in obliquely opposite rounded corners of the connecting flange, a respective diameter of the two recesses corresponding, in particular, to a respective diameter of the mounting bores.

In a further embodiment, the two obliquely opposite rounded corners of the flange-like projection, in which in each case one of the two recesses for leading through fastening means is arranged, each have a smaller radial extent than the two obliquely opposite rounded corners of the connecting flange, in which in each case one of the two mounting bores is arranged.

In a further embodiment, the flange-like projection has a second sealing lip, the second sealing lip
being arranged on that side of the flange-like projection which is directed in the insertion direction of the contact element carrier into the housing pot (or in the axial direction of the centre axis),
running completely around the flange-like projection,
running completely (in a circular manner) around in each case one of the two recesses for leading through fastening means, and/or
being capable of being placed onto the mounting plate in such a way that a press fit is configured between the second sealing lip and the mounting plate, the press fit which is configured between the second sealing lip and the mounting plate, in particular, being impermeable (in both directions) for water and/or air.

In some specific embodiments, the housing pot of the mounting plug-in connector according to the invention has a flange-like projection which, in the case of screwing of the connecting flange onto the mounting plate, is pressed both onto the connecting flange and onto the mounting plate, and therefore acts, inter alia, as a seal between these two parts. By virtue of the fact that the flange-like projection, just like the housing pot, consists of the soft, rubber-like material, the flange-like projection is compressed greatly, in particular, in the regions around the screw leadthroughs. Lateral swelling out of the flange-like projection below the connecting flange at these greatly compressed locations is prevented by virtue of the fact that the flange-like projection has a smaller extent in these regions than the connecting flange. The first and second sealing lip each serve to configure a corresponding press fit which seals even in the case of a small contact pressure.

In a further embodiment, the at least one push-out opening is positioned within the housing bottom in such a way that the push-out opening
is spaced apart by from 2 mm to 6 mm, in particular by from 3 mm to 5 mm, from an outer edge of the housing bottom, and/or
by from 5 mm to 9 mm, in particular by from 6 mm to 8 mm, from a centre point of the housing bottom.

In a further embodiment, a wall-like elevation is arranged on a side of the housing bottom which faces the housing interior space, the wall-like elevation
rising up from the housing bottom in a direction opposed to the insertion direction of the contact element carrier into the housing pot (or opposed to the axial direction of the centre axis),
running around the housing bottom, in particular in an annular manner, spaced apart from the housing shell (freestanding, without contact of the housing shell),
having a third sealing lip on a side of the wall-like elevation which is directed towards the centre axis, the third sealing lip extending at least approximately orthogonally (deviation from the perpendicular in the single-digit angular range possible) from that side of the wall-like elevation which is directed towards the centre axis towards the centre axis, and/or
bearing against the contact element carrier which is inserted into the housing pot in the axial direction of the centre axis, in such a way that
a first press fit is configured between the third sealing lip and the contact element carrier, and/or
a second press fit is configured between the wall-like elevation and the contact element carrier,
   the first and/or the second press fit being, in particular, impermeable (in both directions) for water and/or air.

During pushing in and pressing of the contact element carrier onto the housing bottom, in the case of built-in plug-in connectors according to the prior art, the housing shell is pressed slightly to the side in the region of the housing bottom (since, for example, the housing shell is curved inwards, in order thus to bear against the contact element carrier), as a result of which the stress within the housing bottom is increased. This stress increase can have the consequence that the press fit warps and, as a result, becomes leaky between the push-out opening which is arranged in the vicinity of the housing shell and a contact element which is situated in this opening. As has already been described above, this problem is likewise solved by virtue of the fact that the contact point between the push-out opening and the contact element is additionally sealed by means of sealing means such as, for example, adhesives, sealing pastes or O-rings. In contrast, the built-in plug-in connector according to the invention solves the problem of the stress which occurs in the housing bottom and the associated leak between the push-out opening in the contact element by virtue of the fact that the wall-like elevation is arranged in a freestanding manner and without contact to the housing shell in the housing interior space. In this way, during pushing in of the contact element carrier as far as the housing bottom, the wall-like elevation is pressed somewhat to the side by way of the contact element carrier, and the first press fit is thus configured between the third sealing lip and the contact element carrier and/or the second press fit is configured between the wall-like elevation and the contact element carrier, without a stress increase occurring within the housing bottom (it can also be said colloquially that the wall-like elevation has “some play” and can thus be pressed away without deformation of the housing bottom).

In a further embodiment, three push-openings extend within the housing bottom.

In a further embodiment, a (contact element) separating element is arranged on an outer side of the housing bottom, the separating element
rising up (in the axial direction with respect to the centre axis of the housing pot) further from the housing bottom than the contact element which is pushed at least partially through the at least one push-out opening, and/or
extending on the housing bottom (orthogonally with respect to the centre axis of the housing pot) in such a way that a radial extent of the separating element on the housing bottom is smaller than or equal to a radial extent of the housing bottom.

In a further embodiment, the separating element is configured as an separating wall between
in each case two of the three push-out openings which extend within the housing bottom, and/or
in each case two of three contact elements which are pushed in each case at least partially through one of the three push-out openings,
   the separating wall being configured, in particular, as a three-pointed star, the centre of symmetry (centre point) of which is arranged on the housing bottom coaxially with respect to the centre axis of the housing pot.

In a further embodiment, the housing shell which is, in particular, cylindrical and the contact element carrier each have a radial extent which is such that a press fit is configured between the housing shell which is, in particular, cylindrical and the contact element carrier which is inserted at least partially through the insertion opening into the housing pot.

In a further embodiment, the following parts of the housing pot are configured in one piece:
the housing shell, the housing bottom and the plug-in-side end,
the housing shell, the housing bottom, the plug-in-side end and the flange-like projection,
the housing shell, the housing bottom, the plug-in-side end, the flange-like projection, the radially projecting connecting strip and the sealing plug which is, in particular, pot-shaped, or
the housing shell, the housing bottom, the plug-in-side end, the flange-like projection, the radially projecting connecting strip, the sealing plug which is, in particular, pot-shaped, and the separating element.

In a further embodiment, the parts of the housing pot which are configured in one piece are made from the material with the Shore A hardness in the range from 60 to 100, the parts of the housing pot which are configured in one piece being manufactured, in particular, by means of injection moulding methods, pressing in or vulcanizing.

By virtue of the fact that as many of the abovementioned parts of the housing pot as possible are manufactured in one piece from the soft flexible material, no contact points, gaps, transitions, etc. exist between these parts, at which leaks can occur or which have to be sealed additionally by means of an O-ring or adhesive. In this way, sealing materials and working steps are likewise saved in comparison with the prior art. Furthermore, all the functions of the housing pot are combined in one part, which in turn makes simplified handling possible (or a simplified assembly, since fewer parts have to be plugged together).

The injection moulding method makes simple manufacturing of the respective parts of the housing pot and, in particular, simple manufacturing of the housing pot which is configured in one piece from these parts possible. For manufacturing by means of injection moulding method, it is necessary that the material which is used can first of all be melted and can then be injected into the corresponding mould. Furthermore, the material has to be capable of solidifying in the corresponding mould by way of cooling and maintaining this solidified shape until renewed heating. It is therefore particularly advantageous that the soft material has a thermoplastic or consists predominantly of this thermoplastic (or thermoplastic elastomer) (additives such as plasticizers or fire prevention substances are frequently mixed in), since a multiplicity of the thermoplastics have the above-described properties and can therefore be used for the injection moulding method. Furthermore, some thermoplastics have a Shore hardness, in particular amorphous thermoplastics such as Low Density Polyethylene (LDPE), atactic polypropylene (PP-at) or atactic polystyrene (PS-at), which lies very close to the Shore hardness of the soft material of the housing pot.

Advantages of a production of the housing pot according to the invention by means of injection moulding methods lie in the fact that the injection moulding method firstly permits production with high precision, and secondly different components (for example, plastic and fire prevention substances) can be added in different proportions in the manner of a “recipe”. A check can subsequently be carried out as to whether the final product has the desired material properties in the case of the recipe which is used, and the recipe can possibly be adapted.

A further advantage of one embodiment of the housing pot according to the invention in comparison with the prior art lies in the fact that, despite the addition of a fire prevention substance, the housing pot has the abovementioned Shore A hardness. The production of a flame-retarding V0 material of this type in this Shore A hardness range is a great challenge, since materials which have been provided with a fire prevention substance have up to now become very hard and brittle and have thus lost their sealing action. Flame retarding is of great importance, in particular, for the built-in plugs of the powerCON, since these plugs have to meet the UL94 standard (that is to say, the material and plug have to be certified V0 according to UL 94 at 1 mm). On account of the standards or requirements of the standards, it is advantageous that a flame retarding means (a certain proportion of a flame-retarding additive) is added in this material. The protection category can be defined via the percentage of the flame-retarding additive which is added to the overall mixture.

Furthermore, the material of the housing pot can also be UV-stabilized in a further embodiment (according to UN standard UL50E, and therefore needs a UL certificate f1). For this purpose, a UV stabilizers of from 10 to 15% by weight or 10 to 15 mol % or 10 to 15% by volume are added to the material. As a result of the UV stabilization, the mounting plug-in connector according to the invention or the housing pot according to the invention can be used in the outdoor area. The product series “True Outdoor Protection” (TOP) from the company Neutrik AG from Liechtenstein (also known under the name Neutrik Group) can be used by way of example for this.

The soft material of the housing pot according to the invention is configured, moreover, in such a way that, in the case of manufacturing of the housing by means of injection moulding method, what are known as undercuts can also be realised, which makes the configuration of the first sealing lip or the wall-like elevation possible, for example.

In one exemplary embodiment of the built-in plug-in connector according to the invention, the contact is carrier is made from a material with a Shore D hardness in the range from 60 to 100.

Although a main function of the contact element carrier is receiving the (in particular, three) contact elements (also called pins or sheets), the term contact element carrier is understood to mean not only a pure contact element holder. Rather, the contact element carrier also has the task of providing the socket for receiving the cable plug and elements for locking the cable plug in this socket. Furthermore, in specific embodiments, the contact element carrier provides the connecting flange, through the mounting bores of which screws are guided for squaring the contact element carrier to the mounting plate (for example, of a loudspeaker box). Here, the connecting flange is pressed onto the mounting plate and therefore prevents the contact element carrier or the entire built-in plug-in connector slipping through the recess in the mounting plate. In the case of built-in plug-in connector housings according to the prior art, the housing is often opened via the contact element carrier, without itself having a flange-like projection which can likewise press onto the mounting plate or can be screwed onto the latter. In addition to the abovementioned functions, the contact element carrier therefore also serves to serve as a type of skeleton or supporting structure which receives the further parts of the built-in plug-in connector or is surrounded by them, defines, as a supporting and shaping structure, for example the built-in plug-in connector interior space provided for receiving and locking the cable plug-in connector, and makes the fixing of the built-in plug-in connector on the mounting plate possible.

Since the contact element carrier is provided to configure the supporting structure/skeleton of the built-in plug-in connector, it is particularly advantageous if the contact element carrier consists of a harder material than the housing pot. Since, in one advantageous embodiment, the contact element is manufactured, just like the housing pot, by means of injection moulding method, pressing or vulcanizing, it is particularly advantageous if the material of the contact element carrier has a thermoplastic, in particular consists predominantly of this thermoplastic. Since, in this exemplary embodiment, the contact element carrier has a Shore hardness in a certain region, it is particularly advantageous to use, for the material of the contact element carrier, as thermoplastic which has a similar Shore hardness. For this purpose, semi-crystalline thermoplastics such as, for example, isotactic PP, isotactic PS or High Density Polyethylene (HDPE) would come into question.

In a further embodiment, the contact element carrier is inserted at least partially into the housing pot (in the axial direction of the centre axis of the housing pot) in such a way that
the centre axis of the contact element carrier and the centre axis of the housing pot are coaxial,
the end piece on that side of the housing bottom which faces the housing interior space is guided at least partially past the wall-like elevation and, in particular, also past the third sealing lip, and/or comes into contact at least partially on the wall-like elevation, with the result that
a first press fit is configured between the third sealing lip and the contact element carrier, and/or
a second press fit is configured between the wall-like elevation and the contact element carrier,
   the first and/or the second press fit being, in particular, impermeable (in both directions) for water and/or air, and/or
the at least one contact element receiving element is brought into congruence with the at least one push-out opening which extends within the housing bottom, in such a way that the contact element which is situated in the at least one contact element receiving opening is pushed out of the built-in plug-in connector in the axial direction of the centre axis of the housing pot at least partially through the at least one push-out opening.

In a further embodiment, the at least one contact element has
a first part region which is received by the contact element carrier (for example, by way of insertion into the at least one contact element receiving opening) in such a way and is fixed within the built-in plug-in connector in such a way that the first part region, in the case of a cable plug-in connector which is inserted into the plug-in opening, comes into contact with the cable plug-in connector-side contact element counterpart and, as a result, provides the signal transmission over the plug-in connection, and
a second part region which projects out of the contact element carrier (that is to say, rises up from the end piece in the axial direction with respect to the insertion direction of the contact element carrier into the housing pot) in such a way that the second part region is pushed out of the built-in plug-in connector (in the axial direction with respect to the insertion direction of the contact element carrier into the housing pot) through the at least one push-out opening, and thus rises up from the housing bottom (in the axial direction with respect to the insertion direction of the contact element carrier into the housing pot), with the result that the second part region can make contact with a cable end piece, in particular a strand, of a cable which is provided to provide a signal which is provided for the signal transmission over the plug-in connector, in particular the current supply signal, the digital signal or the analog signal, (for example, via crimping, welding, soldering or clamping using specific clamps),
   the first part region and the second part region being configured in one piece.

In a further embodiment,
three contact elements are received at least partially by the contact element carrier, and/or
three push-out openings extend within the housing bottom.

In a further embodiment, the built-in plug-in connector is provided to enter into the mechanically lockable plug-in connection to a cable plug-in connector
of the three-pole power plug-in connector type (for example, a powerCON plug from the company Neutrik AG from Liechtenstein (also known under the name Neutrik Group)), the built-in plug-in connector being configured, in particular, as a three-pole power supply female receptacle (for example, a powerCON female receptacle from the company Neutrik AG from Liechtenstein (also known under the name Neutrik Group), or
of the following cable plug-in connector types:
IEC,
XLR,
RJ45,
HDMI,
USB, or
RCA,
   the built-in plug-in connector being configured, in particular, as a female receptacle which is adapted correspondingly to this cable plug-in connector type.

In a further embodiment, the built-in plug-in connector is to be inserted into a mounting plate recess in such a way that
the housing pot bears against and is supported on an inner surface of a mounting plate recess (for example, the housing pot bears by way of the housing shell), and/or
the flange-like projection bears against the front side of the mounting plate on a side of the flange-like projection which is directed towards a front side of the mounting plate (that is to say, on that side of the flange-like projection which is directed in the axial direction of the centre axis of the housing pot), the front side of the mounting plate being directed in the direction from which the cable plug-in connector can be guided onto the built-in plug-in connector which is situated in the state in which it is built-in on the mounting plate.

In a further embodiment, the contact element carrier has, in order to provide a mechanically lockable plug-in connection, a locking mechanism for the cable plug-in connector, the contact element carrier interior space, in particular,
having a mechanical restraining element which is provided to block a cable plug-in connector-side restraining element counterpart with regard to an axial movement in the cable plug-in connector pull-out direction within the context of a first part of a locking mechanism which can be actuated by way of a rotation, taking place in a screwing-in direction, of the cable plug-in connector in a state of the cable plug-in connector, in which it is pushed at least partially into the contact element carrier interior space (and accordingly also into the built-in plug-in connector), and
having a mechanical closing element which is provided, within the context of a second part of the locking mechanism which can be actuated by way of displacement of a cable plug-in connector-side bolt slide, to bring about an engagement of a bolt, connected to the bolt slide, of the cable plug-in connector into the closing element and therefore to block the cable plug-in connector with regard to a rotation in the growing-out direction which is directed counter to the screwing-in direction.

In a further embodiment, the restraining element is arranged and configured in such a way that the restraining element counterpart engages behind the restraining element after actuation of the first part of the locking mechanism.

In a further embodiment,
the mechanical restraining element is configured as a groove arrangement, grooves of the groove arrangement first of all extending axially, and, as a result, serving, in particular, as key counterparts for key elements of the cable plug-in connector, and then running perpendicularly with respect to the axis or slightly obliquely with respect perpendicularly with respect to the axis and serving in this region as restraining component, the restraining element counterpart being configured as a lug arrangement which is inserted into the groove arrangement by way of the entering of the plug-in connection, and being blocked against being pulled out axially by way of the groove arrangement region which runs perpendicularly or slightly obliquely with respect perpendicularly with respect to the axis, or
the mechanical restraining element is configured as a lug arrangement, and the restraining element counterpart is configured as a groove arrangement, grooves of the groove arrangement first of all extending axially in the plugged-in state, and, as a result, serving as key elements for the lug arrangement which serve, in particular, as key counterparts, and then running perpendicularly with respect to the axis or slightly obliquely with respect to perpendicularly with respect to the axis, the groove arrangement region which extends perpendicularly or slightly obliquely with respect perpendicularly with respect to the axis engaging behind the lug arrangement as a result of entering of the plug-in connection and, as a result, the cable plug opening connector being blocked against being pulled out axially.

In a further embodiment, the restraining element is arranged in such a way and provided with an oblique course in such a way that, as a result of and in the case of actuation of the first part of the locking mechanism, the restraining element counterpart is moved along the oblique course until the restraining element counterpart comes into contact with a rotational stop, and an end plug-in position of the cable plug-in connector in the contact element carrier interior space (and therefore also in the built-in plug opening connector) is reached.

In a further embodiment, the contact element carrier interior space has mechanical key counterparts which are provided to interact with key elements, matched to them, of the cable plug opening connector in such a way that the cable plug-in connector can be plugged into the built-in plug-in connector in only a specific rotational orientation which is predefined by way of the key counterparts.

The invention additionally relates to a housing pot (or a built-in plug-in connector housing) for a built-in plug-in connector in accordance with one of the above-described embodiments (or according to one of claims 1 to 14).

### BRIEF DESCRIPTION OF THE DRAWINGS

The housing pot according to the invention and the built-in plug-in connector according to the invention will be described in greater detail in the following text purely by way of example on the basis of exemplary embodiments which are shown diagrammatically in the figures. Identical elements are labelled in the figures with identical reference numerals. The described embodiments are as a rule not shown to scale, and they are not to be understood as a restriction either. In detail:

FIGS. 1A-1B show a perspective view of one exemplary embodiment of the housing pot according to the invention,

FIGS. 2A-2B show a perspective view of one exemplary embodiment of the housing pot according to the invention,

FIG. 3 shows a front view of one exemplary embodiment of the built-in plug-in connector according to the invention,

FIG. 4 shows a rear view of one exemplary embodiment of the built-in plug-in connector according to the invention,

FIG. 5 shows a perspective view of one exemplary embodiment of the built-in plug-in connector according to the invention,

FIG. 6 shows a perspective view of an exploded illustration of one exemplary embodiment of the built-in plug-in connector according to the invention,

FIG. 7 shows a side view of one exemplary embodiment of the built-in plug-in connector according to the invention,

FIG. 8 shows a side view of an exploded illustration of one exemplary embodiment of the built-in plug-in connector according to the invention,

FIGS. 9A-9B show a diagrammatic illustration of the housing interior space before and after the insertion of the contact element carrier and the guiding of a contact element through the push-out opening in the case of built-in plug-in connectors according to the prior art,

FIGS. 10A-10B show a diagrammatic illustration of the stress which occurs within the housing bottom in the case of built-in plug-in connectors according to the prior art,

FIGS. 11A-11B shows a diagrammatic illustration of the housing interior space, in particular of the push-out opening and the wall-like elevation, before and after the insertion of the contact element carrier and the guiding of a contact element through the push-out opening in the case of the built-in plug-in connector according to the invention,

FIG. 12 shows a diagrammatic illustration of the arrangement of a connecting flange, a flange-like projection and a mounting plate in the case of the built-in plug-in connector according to the invention,

FIGS. 13-14 show perspective views of a further exemplary embodiment of the built-in plug-in connector according to the invention which is configured as a double-unit plug-in connector,

FIGS. 15-17 show perspective views in an exploded illustration of the built-in plug-in connector which is shown in FIGS. 13-14,

FIGS. 18A-18B show perspective views of a further exemplary embodiment of the built-in plug-in connector according to the invention, for rear fastening to a mounting plate, and

FIGS. 19A-19B show perspective views in an exploded illustration of the built-in plug-in connector which is shown in FIGS. 18A-18B.

### DETAILED DESCRIPTION

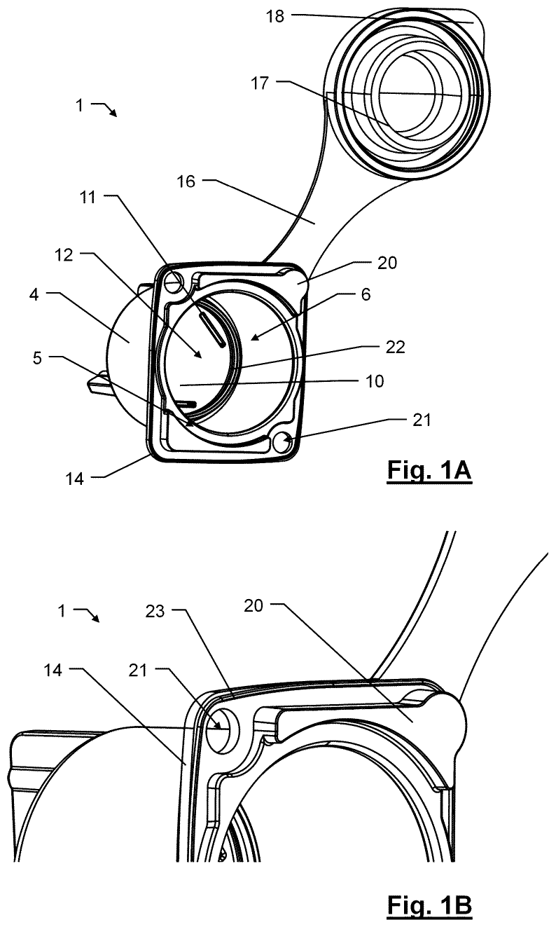

FIG. 1A shows a perspective view of one exemplary embodiment of the housing pot 1 according to the invention, in the case of which the cylindrical housing shell 4, the circular housing bottom 10, the flange-like projection 14 of predominantly rectangular configuration, the connecting strip 16, the pot-shaped sealing plug 17, the grip tab 18 and the separating/insulating element 19 are configured in one piece. The insertion opening 6 extends in the plug-in-side end 5 of the housing 1, on which the flange-like projection 14 extends radially. In this embodiment of the housing 1, the housing bottom 10 has three push-out openings 11.

FIG. 1B illustrates the elevation 20 which is configured to be pushed into a corresponding depression of the connecting flange 15 and to be held in this depression with a press fit, as a result of which the housing 1 and the contact element 7 are held together fixedly. Furthermore, the first sealing lip 23 is illustrated which is provided to seal the contact region of the flange-like projection 14 with the connecting flange 15.

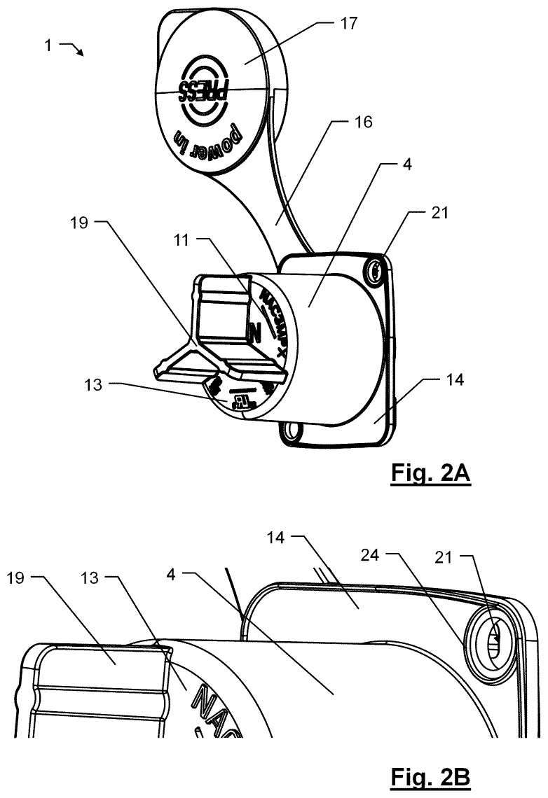

FIGS. 2A and 2B show a perspective view of one exemplary embodiment of the housing pot 1 according to the invention, this exemplary embodiment of the housing pot 1 according to the invention having, furthermore, the second sealing lip 24. This second sealing lip 24 is provided to run around the flange-like projection 14 in the edge region and the recess 21 which is provided for guiding through fastening means, and thus to seal the contact region of the flange-like projection 14 with the mounting plate.

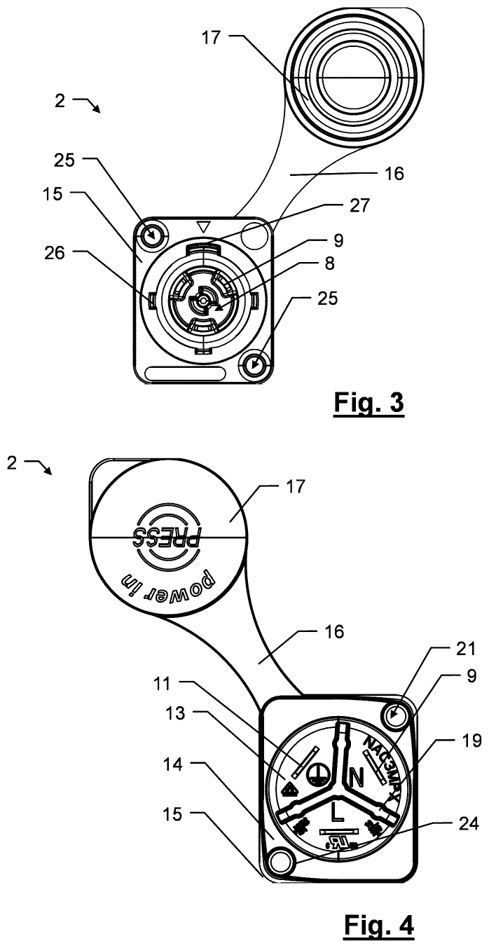

FIG. 3 shows a front view of one exemplary embodiment of the built-in plug-in connector 2 according to the invention, which front view illustrates the mounting bores 25, the restraining elements 26 which are configured as grooves, the mechanical closing element 27 which is provided for the bolt of the cable plug-in connector-side bolt slide, and the plug-in opening 8 which is provided for the insertion of the cable plug-in connector into the built-in plug-in connector.

FIG. 4 shows a rear view of one exemplary embodiment of the built-in plug-in connector 2 according to the invention which illustrates the separating element 19 which is configured as a three-pointed star. Furthermore, the arrangement of the connecting strip 16 and a rounded corner of the housing 1 can be seen, the connecting strip being arranged obliquely (along the diagonal from one corner to the other corner of the housing) in such a way that an angle of approximately 135° is configured between one side of the flange-like projection 14 and the connecting strip 16.

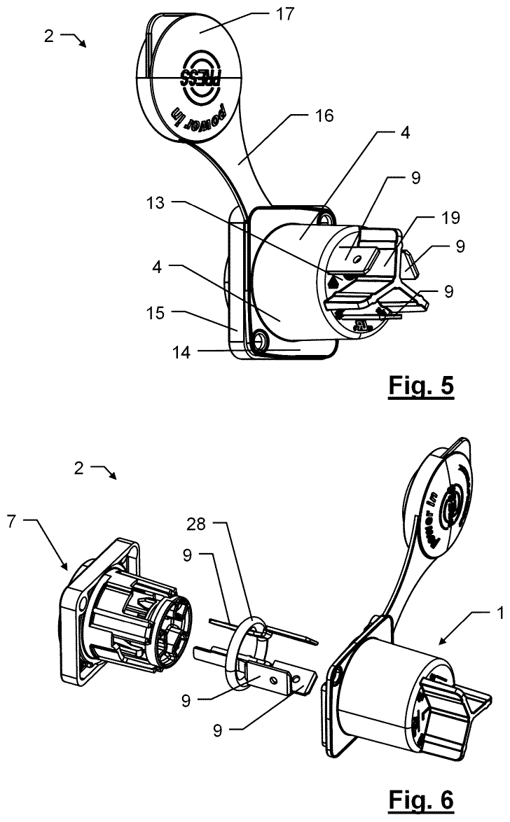

FIG. 5 shows a perspective view of one exemplary embodiment of the built-in plug-in connector 2 according to the invention, and FIG. 6 shows the corresponding perspective view of an exploded illustration of one exemplary embodiment of the built-in plug-in connector 2 according to the invention. Here, the sealing ring 28 is arranged within the contact element carrier 7 and serves as an additional seal if one of the above-described press fits 1 should become leaky on account of, for example, material fatigue/material ageing.

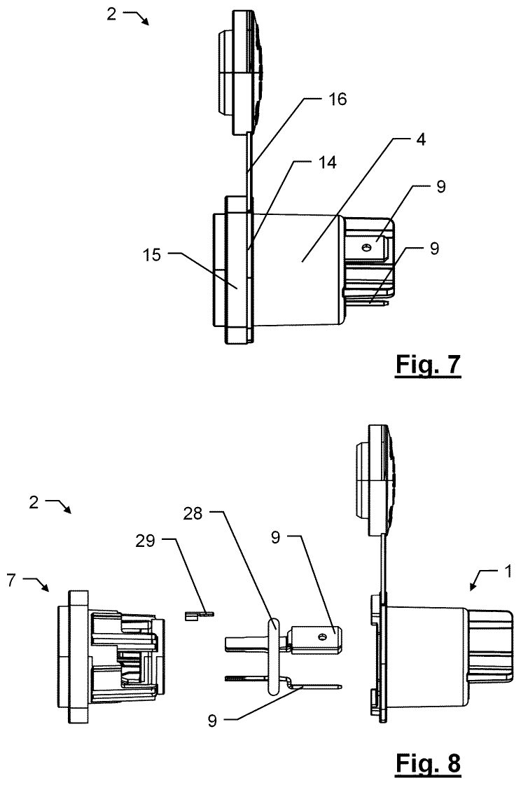

FIG. 7 shows a side view of one exemplary embodiment of the built-in plug-in connector 2 according to the invention, and FIG. 8 shows a side view of an exploded illustration of one exemplary embodiment of the built-in plug-in connector 2 according to the invention. These two figures serve for further illustration of the built-in plug-in connector 2 according to the invention. The element 29 serves as additional fixing of the contact element carrier 7 in the housing 1.

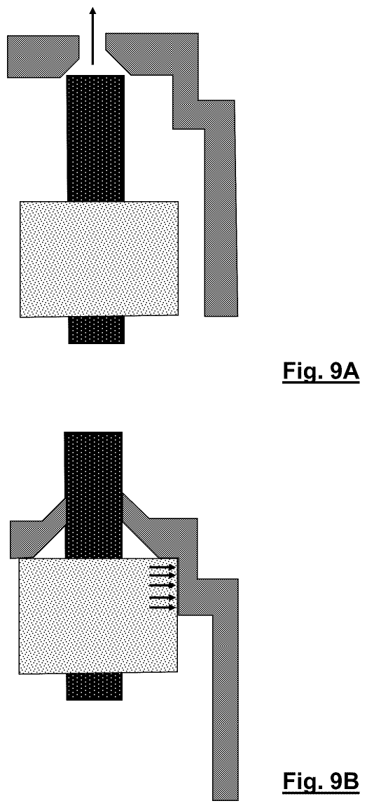

FIG. 9A shows a diagrammatic illustration of the housing interior space before and FIG. 9B shows a diagrammatic illustration of the housing interior space after the insertion of the contact element carrier and the leading of a contact element through the push-out opening in the case of built-in plug-in connectors according to the prior art. Here, the push-out opening is configured with a smaller area than the cross-sectional area of the contact element, in order thus to ensure opening out of the edge of the push-out opening during guiding through of the contact element. Here, the opened region bears against the contact element by means of press fit, the press fit not being configured over the entire thickness of the housing bottom, however. In order to facilitate the guiding through of the contact element and the opening out of the edge region, the push-out opening is of funnel-shaped configuration. As has already been described above, a small positive pressure within the built-in plug-in connector is sufficient in the case of an embodiment of this type, however, to press open the outwardly opened edge region of the push-out opening and thus to again create a leak of the built-in plug.

Furthermore, FIG. 9B illustrates how the housing shell which is curved into the housing interior space in the region of the housing bottom configures a type of step, on which a force acts during pushing in and pressing of the contact element carrier or a sealing means such as, for example, an O-ring onto the housing bottom (labelled here by way of the arrows), as a result of which the housing shell is pressed (slightly) to the side in the region of the housing bottom. As has already been described above, this leads to the stress within the housing bottom being increased.

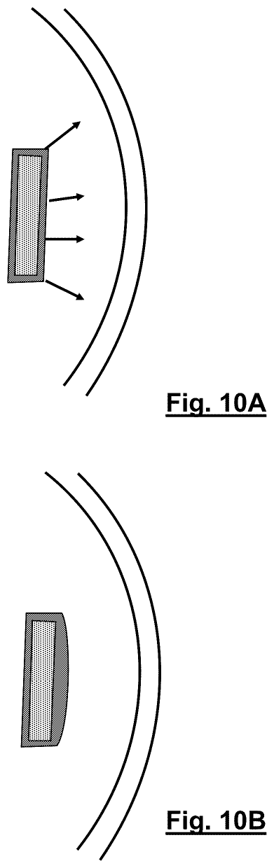

This stress increase within the housing bottom in the case of built-in plug-in connectors according to the prior art is illustrated in FIG. 10A by way of the arrows which are directed in the direction of the housing shell, which stress increase is transmitted to the push-out opening arranged in the vicinity and ensures that the latter is warped and becomes leaky as a result, as shown in FIG. 10B.

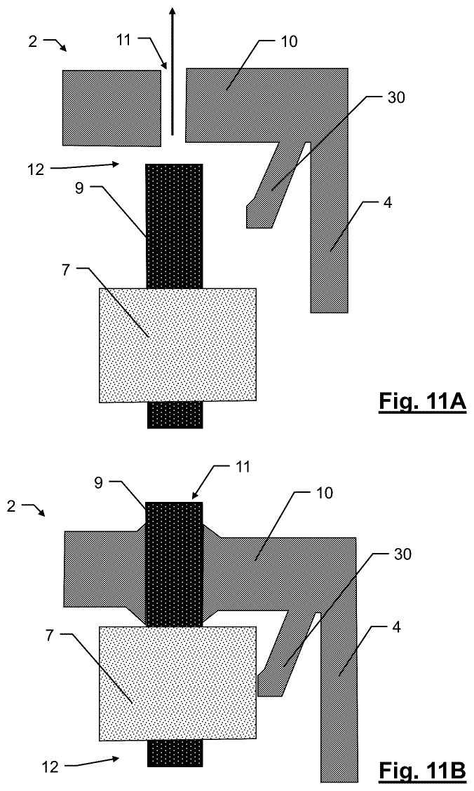

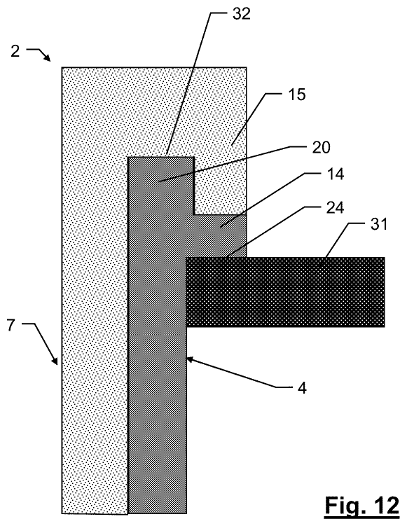

FIG. 11A shows a diagrammatic illustration of the housing interior space 12, in particular the push-out opening 11 and the wall-like elevation 30, before, and FIG. 11B shows it after the insertion of the contact element carrier 7 and the guiding of a contact element 9 through the push-out opening 11 in the case of the built-in plug-in connector 2 according to the invention.

On account of the soft material of the housing pot 1, the contact element 9 can be guided through the push-out opening 11 very simply even without a funnel-shaped configuration. By virtue of the fact that the geometrical shape and that the area of the push-out opening 11 are adapted to the cross-sectional area of the contact element 9, it is possible in the case of the housing pot 1 according to the invention for the contact element 9 to be pushed through the push-out opening 11, without its edge or its inner surface (also called the area which extends into the push-out opening 11) opening/curving outwards. Here, the housing bottom 10 is much rather pressed somewhat to the side by way of the contact element 9 (which is readily possible in the case of the elastic material of the housing 1 without a relatively great stress increase in the housing bottom 10), as a result of which the inner area of the opening 11 is stretched somewhat in some circumstances, but continues to bear against the contact element 9 with a full surface area. In other words, the press fit of the contact element 9 in the push-out opening 11 bears against the contact element 9 over the entire area within the push-out opening (inner area).

In that exemplary embodiment of the built-in plug-in connector 2 according to the invention which is shown, the area of the push-out opening 11 has been selected in such a way that the inner area of the opening 11 is stretched when the contact element 9 is pushed through. In this way, elevations which bear against the contact element 9 are configured both on the inner side and on the outer side 13 of the housing bottom 10, which elevations prevent, in the case of a positive or negative pressure within the built-in plug-in connector 2 and in the case of a positive or negative pressure outside the built-in plug-in connector 2, that the housing bottom 10 is pressed outwards or inwards at the contact point with the contact element 9.

FIGS. 11A and 11B illustrate, furthermore, that, in the case of the built-in plug-in connector 2 according to the invention, the wall-like elevation 30 is arranged in a freestanding manner and without contact with the housing shell 4 in the housing interior space 12, in particular on the housing bottom 10. If, as shown in FIG. 11B, the contact element carrier 7 is then pushed in as far as the housing bottom 10, the wall-like elevation 30 is pressed (somewhat) to the side by way of the contact element carrier 7, as a result of which the second press fit is configured between the wall-like elevation 30 and the contact element carrier 7. In one exemplary embodiment of the built-in plug-in connector 2, the wall-like elevation 30 has a third sealing lip (extending orthogonally with respect to the centre axis of the housing pot 1 from the wall-like elevation 30 towards the centre axis of the housing pot 1) which bears against the pushed-in contact element carrier 7 in such a way that the first press fit is configured between the third sealing lip and the contact element carrier 7.

By virtue of the fact that the wall-like elevation 30 is attached to the housing bottom 10 in a free-standing manner and without contact with the housing shell 4, it can be pressed to the side by way of the pushed-in contact element carrier 7, without the housing shell 4 being pressed outwards in the region of the housing bottom and the stress within the housing bottom 10 increasing.

It is prevented in this way that the push-out opening 11 which is arranged close to the housing shell 4 is warped, and thus the press fit between the inner area of the push-out opening 11 and a contact element 9 which is guided through becomes leaky. As a consequence, subsequent sealing of the contact point between the inner area of the push-out opening 11 and the contact element 9 which is guided through by means of an additional sealing means such as an O-ring or an adhesive which is initially liquid and hardens over time is unnecessary in the case of the housing pot 1 according to the invention or the built-in plug-in connector 2 according to the invention in comparison with the previously known solutions from the prior art.

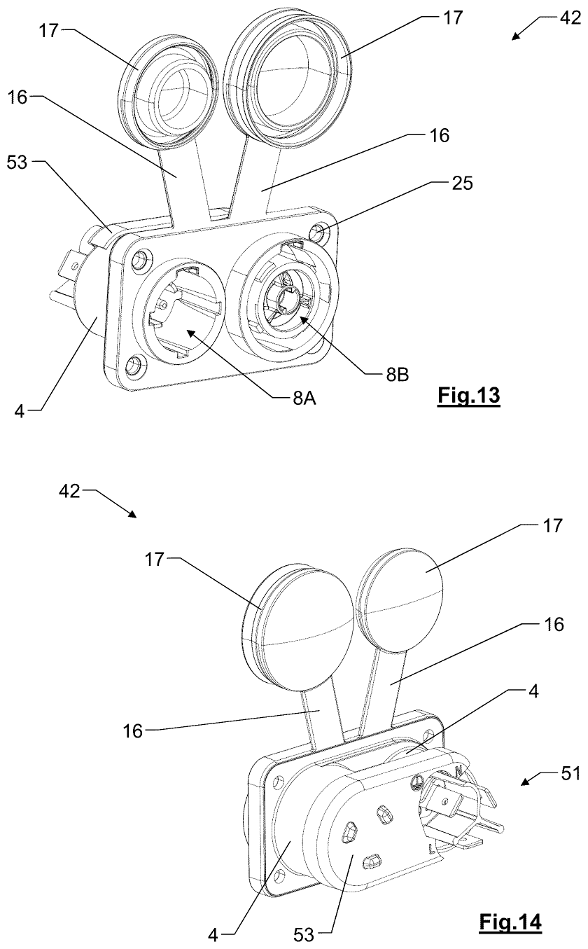

FIG. 12 shows a diagrammatic illustration of the arrangement of a connecting flange 15, a flange-like projection 14 and a mounting plate 31 in the case of the built-in plug-in connector 2 according to the invention.

In the exemplary embodiment which is shown, the flange-like projection 14 has an elevation 20 which is directed in an opposed manner with respect to the axial direction of the centre axis, the elevation 20 of the flange-like projection 14 being pushed into a depression 32, matched to it, of the connecting flange 15 of the contact element carrier 7 in such a way that a press fit is configured between the elevation 20 and the depression 32 which is matched to it. Furthermore, it is illustrated that the flange-like projection 14 has an identical radial extent to the connecting flange 15, with the result that the flange-like projection 14 which is placed onto the connecting flange 15 terminates flush with the connecting flange 15.

If, as shown in FIG. 12, the built-in plug-in connector 2 is then inserted into a recess in the mounting plate 31, the housing shell 4 firstly bears against an inner area of this recess, and the flange-like projection 14, in particular the second sealing lip 24 which is arranged on that side of the flange-like projection 14 which is directed in the axial direction, then bears against the front side of the mounting plate 31. The front side of the mounting plate 31 is directed to where the cable plug-in connector can be guided onto the built-in/mounted plug-in connector 2 which is situated in the state, in which it is built-in on the mounting plate 31. By way of screwing the connecting flange 15 onto the mounting plate 31, the connecting flange 15 not making contact with the mounting plate 31 in this embodiment, the flange-like projection 14 which lies in between, in particular the second sealing lip 24, of the housing 1 is pressed onto the mounting plate 31, as a result of which this contact point between the built-in plug-in connector 2 and the mounting plate 31 becomes impermeable for dust, moisture and/or air. In this way, in the case of the built-in plug-in connector 2 according to the invention, the contact point between the built-in plug-in connector 2 and the mounting plate 31 is already tight with respect to dust, water and/or air even without the use of additional sealing means.

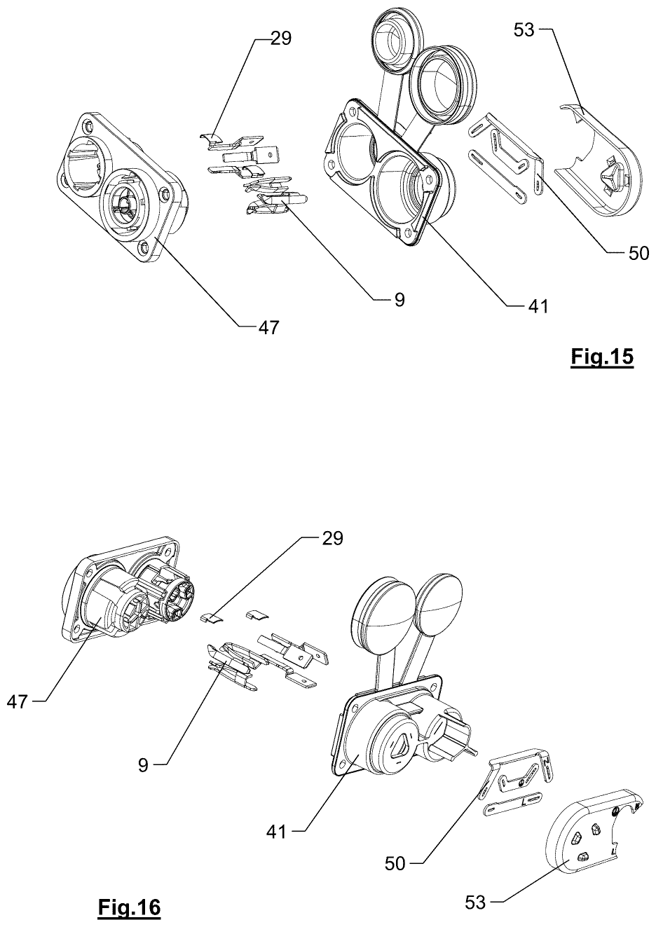

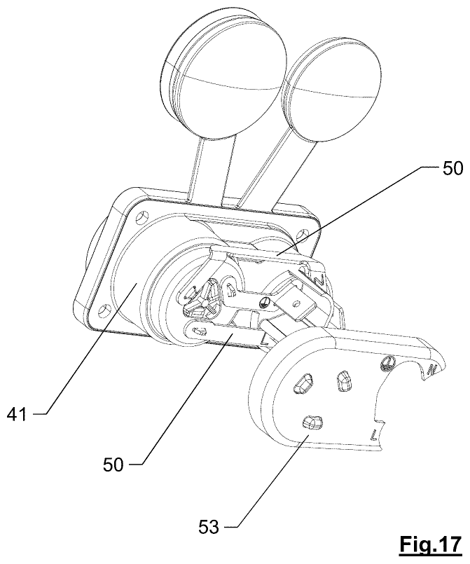

FIG. 13 and FIG. 14 each show perspective views, and FIGS. 15, 16, 17 show associated perspective views in an exploded illustration of one exemplary embodiment of the built-in plug-in connector 42 according to the invention, the built-in plug-in connector 42 being configured as a double-unit plug-in connector, a housing pot pair 41 which is configured in one piece and a contact element carrier pair 47, matched to the former, which is configured in one piece forming a common flange element for two plug-in openings 8A, 8B which are provided through the housing pot pair 41.

The housing pots of the housing pot pair 41 and the contact element carriers of the contact element carrier pair 47 are each configured substantially as described at the outset, one housing pot/contact element carrier combination being configured to provide a signal input plug-in opening 8A, however, and the other housing pot/contact element carrier combination being configured to provide a signal output plug-in opening 8B. The flange element which is provided by way of the housing pot pair 41 and the contact element carrier pair 47 has fastening measures 25, for example in the form of bores for receiving fastening means for fastening the built-in plug-in connector to a mounting plate.

Furthermore, the built-in plug-in connector 42 has connecting elements 50 which connect the contact elements 9 for the signal input plug-in opening 8A and the signal output plug-in opening 8B to one another in such a way that the contact elements of the signal input plug-in opening 8A and the signal output plug-in opening 8B are conducted to a common connector element 51. The contact elements 9, housing pots of the housing pot pair 41 and the contact element carriers of the contact element carrier pair 47 are each configured in such a way that they interact in an analogous manner with respect to the embodiments of the built-in plug-in connector which are described in FIGS. 1 to 6. The covering plate 53 covers the exposed conducting elements for connecting the contact elements 9 of the signal input plug-in opening 8A and the signal output plug-in opening 8B. In an analogous way with respect to the embodiments of the built-in plug-in connector which are described in FIGS. 1 to 6, the element 29 serves as additional fixing of the contact element carrier pair 47 in the housing 1.

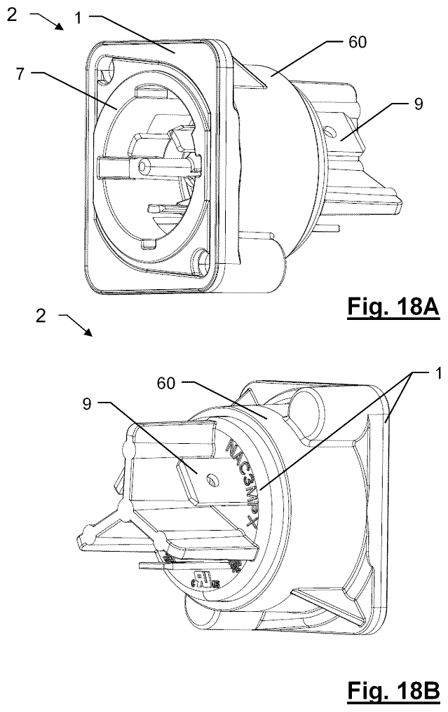

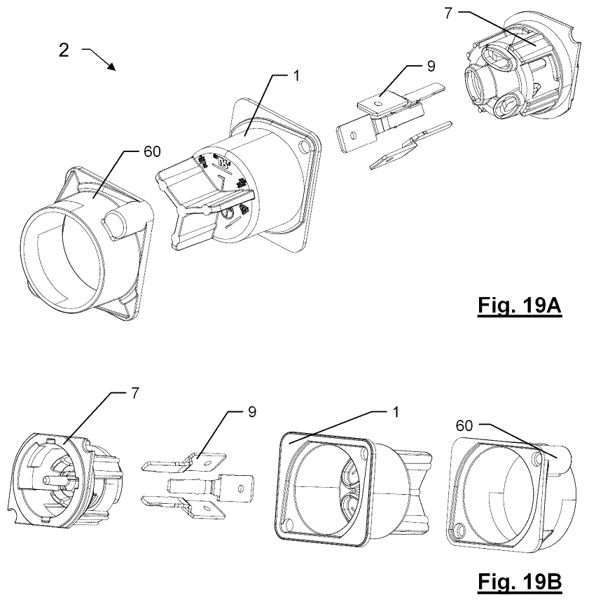

FIG. 18A and FIG. 18B each show perspective views, and FIGS. 19A and 19B show associated perspective views in an exploded illustration of one exemplary embodiment of the built-in plug-in connector 2 according to the invention, the built-in plug-in connector 2 having a supporting flange 60 for rearward fastening to a mounting plate.

The supporting flange 60 has a leadthrough which is adapted to the diameter of the housing shell 4 and through which the housing pot 1 is guided in such a way that firstly the flange-like projection of the housing pot 1 comes to lie (congruently) on the supporting fine 60, the radial extent of the flange-like projection and the supporting flange 60 being identical, in particular, and the housing bottom and the contact elements 9 which are correspondingly guided through secondly leaving the leadthrough of the supporting flange 60 again. Furthermore, on the plug-in side, the supporting flange 60 has a depression, into which an elevation, configured correspondingly as a counterpart and directed rearwards (in a direction away from the mounting plate), of the flange-like projection is pushed with an accurate fit, and the two parts are thus connected to one another, for example by means of press fit.

The supporting flange 60 has, moreover, at least one blind bore, for receiving a fastening means (for example, screw) which comes from a mounting plate for fastening the built-in plug-in connector 2 to the mounting plate. The flange-like projection has at least one recess which is provided for guiding through the fastening means and, in the correctly plugged-together state of the housing pot 1 and the supporting flange 60, comes into congruence with the opening of the blind bore.

In the case of the exemplary embodiment which is shown, the contact element carrier 7 of the built-in plug-in connector 2 according to the invention has a connecting flange which has a smaller radial extent than in the case of other embodiments. This smaller connecting flange is pushed with an accurate fit into a depression, configured correspondingly as a counterpart, of the flange-like projection of the housing pot 1, in such a way that the plug-in-side end of the contact element carrier 7 merges flush into the plug-in-side end of the housing pot 1, and therefore the plug-in-side end of the built-in plug-in connector 2 configures a planar surface in the region of the contact element carrier 7 which is received in the housing pot 1.

In the case of the exemplary embodiment which is shown of the built-in plug-in connector 2 according to the invention, this planar surface is configured to be placed onto the rear side of a mounting plate, a corresponding fastening means (for example, screw) being guided through the mounting plate and the at least one recess of the flange-like projection and then engaging into at least one blind bore.

In a further embodiment of the built-in plug-in connector 2 according to the invention which is shown, the fastening means is not guided directly through the mounting plate for fixing the built-in plug-in connector 2 on the rear side of the mounting plate, but rather a second supporting flange is first of all screwed by means of the fastening means onto the front side of the mounting plate.

One example for a built-in plug-in connector which is placed with a first supporting flange onto the rear side of a mounting plate and additionally also has a second supporting flange which is placed onto the front side of the mounting plate, a fastening means (for example, screw) fixing both the first and the second supporting flange on the mounting plate, is shown in Patent Application PCT/EP2022/065102.

It goes without saying that these figures which are shown only diagrammatically show possible exemplary embodiments. The various approaches can likewise be combined with one another and with methods of the prior art.

1. A built-in plug-in connector for entering into a plug-in connection with a cable plug-in connector which is matched to the built-in plug-in connector as counterpart and is pluggable into an opening of the built-in plug-in connector, a signal transmission being enabled by way of entering of the plug-in connection between the built-in plug-in connector and the cable plug-in connector, the built-in plug-in connector comprising:
at least one contact element that is adapted to come into contact with a cable plug-in connector-side contact element counterpart by way of entering into the plug-in connection and, as a result, to provide the signal transmission over the plug-in connection,
a contact element carrier in which the at least one contact element is received to fix the at least one contact element within the built-in plug-in connector, and
a housing pot, the contact element carrier being inserted at least partially into the housing pot,
wherein the housing pot is made from a material with a Shore A hardness in the range from 60 to 100.

2. The built-in plug-in connector according to claim 1, wherein the material is comprised at least predominantly of a plastic.

3. The built-in plug-in connector according to claim 2, wherein the plastic comprises a thermoplastic, including at least one of the following thermoplastics: polypropylene, polyethylene, polyurethane, or polystyrene.

4. The built-in plug-in connector according to claim 1, wherein the housing pot includes
a housing shell having a plug-in-side end, an insertion opening extending within the plug-in-side end, through which insertion opening the contact element carrier is inserted at least partially into the housing pot, and a housing bottom, with at least one push-out opening extending within the housing bottom, through which push-out opening the contact element is pushed at least partially out of the housing pot.

5. The built-in plug-in connector according to claim 4, wherein the at least one push-out opening at least one of:
a) has a geometrical shape which corresponds at least partially to a geometrical shape of a cross-sectional area, running orthogonally with respect to a longitudinal axis through the at least one contact element, of the at least one contact element,
b) extends within the housing bottom with an area which is smaller than or equal to said cross-sectional area of the at least one contact element, or
c) bears with an area which extends into the at least one push-out opening against the at least one contact element which is pushed at least partially through the at least one push-out opening such that a press fit is configured over an entire thickness of the housing bottom between said area and the contact element which is pushed at least partially through the at least one push-out opening.

6. The built-in plug-in connector according to claim 4, wherein the contact element carrier includes a plug-in opening for plugging in the cable plug-in connector, a contact element carrier interior space extends from the plug-in opening as far as an end piece which is spaced apart from the plug-in opening, the end piece provides a stop for the plugged-in cable plug-in connector, has at least one contact element receiving opening, and a connecting flange is arranged at the plug-in opening.

7. The built-in plug-in connector according to claim 6, wherein the plug-in-side end of the housing pot includes a flange-shaped projection that is at least one of a) placed against the connecting flange of the contact element carrier or is placeable against a mounting plate, the flange-shaped projection having an at least largely identical shape and extent to the connecting flange of the contact element carrier, such that the flange-shaped projection which is placed against the connecting flange of the contact element carrier terminates at least largely flush with the connecting flange of the contact element carrier.

8. The built-in plug-in connector according to claim 7, further comprising a radially projecting connecting strip moulded on the flange-shaped projection, a sealing plug fastened to an outer end of the connecting strip, the sealing plug having an external diameter which is greater than an internal diameter of the plug-in opening of the contact element carrier, such that, when the sealing plug is pushed into the plug-in opening, a press fit is configured between the sealing plug and an area which extends into the plug-in opening.

9. The built-in plug-in connector according to claim 8, wherein the flange-shaped projection has a rectangular shape, the radially projecting connecting strip is moulded on a corner of the flange-shaped projection, and the radially projecting connecting strip is moulded on a corner of the flange-shaped projection such that an angle in a range from 120 degrees to 140 degrees is configured between a longer side of two sides of the flange-shaped projection which form said corner.

10. The built-in plug-in connector according to claim 4, further comprising a separating element arranged on an outer side of the housing bottom, the separating element at least one of
a) extends further up from the housing bottom than the contact element which is pushed at least partially through the at least one push-out opening, or
b) extends on the housing bottom such that a radial extent of the separating element on the housing bottom is smaller than or equal to a radial extent of the housing bottom.

11. The built-in plug-in connector according to claim 8, wherein:
the housing shell, the housing bottom and the plug-in-side end of the housing pot are formed as one piece,
the housing shell, the housing bottom, the plug-in-side end and the flange-shaped projection of the housing pot are formed as one piece,
the housing shell, the housing bottom, the plug-in-side end, the flange-shaped projection, the radially projecting connecting strip and the sealing plug of the housing pot are formed as one piece, or
the housing shell, the housing bottom, the plug-in-side end, the flange-shaped projection, the radially projecting connecting strip, the sealing plug and a separating element arranged on an outer side of the housing bottom of the housing pot are formed as one piece.

12. The built-in plug-in connector according to claim 11, wherein the parts of the housing pot which are configured in one piece are made from the material with the Shore A hardness in the range from 60 to 100, and the parts of the housing pot which are configured in one piece are injection moulded, pressed or vulcanized.

13. The built-in plug-in connector according to claim 1, wherein the contact element carrier is made from a material with a Shore D hardness in a range from 60 to 100.

14. The built-in plug-in connector according to claim 4, wherein at least one of
a) three of the contact elements are received by the contact element carrier, or
b) three of the push-out openings extend within the housing bottom.

15. A housing pot for a built-in plug-in connector, the housing pot being adapted to receive a contact element carrier that is inserted at least partially into the housing pot, and the housing pot is comprised of a material with a Shore A hardness in the range from 60 to 100.

16. The built-in plug-in connector of claim 6, wherein at least one of: the area which extends into the at least one push-out opening is not opened out by way of the pushed-out at least one contact element (9), the housing bottom has a thickness in the range from 0.5 mm to 3 mm, or the press fit is configured being impermeable for water and/or air.
